(19) United States
(12) Patent Application Publication
(10) Pub. No.: US 2011/0162298 A1
(43) Pub. Date: Jul. 7, 2011

(54) TWO LAYERS EXTENSIBLE BAND FOR EXTERNAL PROTECTION OF BUILDING STRUCTURES

(76) Inventor: Maurizio Bertozzi, Longiano (FC) (IT)

(21) Appl. No.: 13/062,614

(22) PCT Filed: Sep. 5, 2008
(86) PCT No.: PCT/IT08/00570

§ 371 Date: Mar. 7, 2011

(51) Int. Cl. E04F 13/00; B32B 3/28

(52) U.S. Cl. 52/173.1; 428/181

(57) ABSTRACT

An extensible band consisting of at least two layers for external protection of building structures with irregular surfaces comprises a supporting layer (1) and a covering layer (2) which are connected to each other and in which there is a plurality of micro-folds (3) extending transversally to the direction of elongation, the supporting layer (1) comprising a film (11) made of organic material and the covering layer (2) comprising a film (21) made of ductile metal.

### TECHNICAL FIELD

The present invention relates to a two-layer extensible band for external protection of building structures, in particular if they have irregular surfaces.

### BACKGROUND ART

To protect the external surfaces of building structures from bad weather and keep them efficient with the passage of time, for several decades materials made in multi-layer bands have been used.

The bands most recently used are characterised in that they have at least one direction of elongation in which they increase their linear dimension: in this way, they can easily be adapted to curved or in any case irregular surfaces. To achieve this, these bands have a plurality of folds, or preferably micro-folds, which are substantially parallel with each other and which extend in a direction transversal to the direction of elongation of the band.

For example, there are prior art bands consisting of three or more layers placed on top of each other, plastically deformable, in which a metal upper layer, which may or may not be painted, guarantees suitable protection against UV rays.

Patent DE 195 23 834 describes a flexible covering material of this type, featuring:
an extensible supporting element, consisting of aluminium subjected to annealing in the form of a stretched metal grid with knit ribs;
a non-woven material placed on top of the supporting element and compressed in the direction of band elongation;
a coating consisting of an extensible plastic film, applied on top of the non-woven material, thus forming a coating which completely covers the supporting element.

However, the presence of many layers makes these bands expensive and heavy: indeed, the metal grid is expensive and requires precision working to prevent it from perforating the waterproofmg plastic film.

There are also bands consisting of only two layers with optional additional layers if required. These bands, lighter and less expensive that the previous ones, in their minimum version involve the presence of a supporting layer, containing organic material fibres, and a covering layer, comprising at least one film made of ductile material.

As described in WO2004 005016, the organic material fibres may be natural or artificial, whilst the film made of ductile material is preferably produced using metals, such as lead, copper or aluminium which are annealed.

These bands may involve the presence of additional layers, depending on their intended use. For example, the covering layer may consist of two or more layers: the film of metal material, for example aluminium, may therefore be coated with a layer of paint or, more generally, with a coating consisting of a material that is subject to thermoplastic or plastic deformation, for example bitumen, butyl, or other compounds with high level of resilience. This coating is preferably applied on the covering layer, but it could also be on the supporting layer, or on both sides, or inserted between the covering layer and the supporting layer.

One example configuration could be described as follows, from the bottom upwards: a support consisting of a layer of polyester non-woven fabric, an additional coating consisting of a polyester film, a covering layer consisting of an aluminium film, covered with a layer of paint. Finally, a layer of adhesive, preferably applied to the supporting layer and covered with an easily removable non-adhesive protective film, simplifies fixing the band to the application surface.

However, this type of band has disadvantages in particular conditions of use, such as for the external protection of constructions and building structures.

Indeed, the use of a material with a fabric structure in the composition of the support, and therefore the presence of a permeable non-compact layer in the layering described above, causes the band to be substantially ineffective, since it has been observed that constant exposure to the weather facilitates the formation of moulds, swelling in the covering layer and consequent detachment between the two main layers, with loss of the aluminium layer and of the resistance to UV rays.

### DISCLOSURE OF THE INVENTION

The present invention therefore has for an aim to eliminate the above-mentioned disadvantages. The invention, described in the claims, achieves the above aim thanks to the elimination of layers in which fibres are present, such as those comprising fabrics or non-woven fabrics, thus reducing the band, in its minimum version, to two layers consisting of a film made of organic material and a film made of ductile metal.

The main advantage of the present invention is basically the fact that it adapts well to application on irregular external surfaces, guaranteeing the permanence of its structural characteristics even for long periods of exposure to the weather.

In particular, any possibility of infiltration of liquids or gases which could, cause deterioration of the quality of the protection is eliminated.

### BRIEF DESCRIPTION OF THE DRAWINGS

Further advantages and characteristics of the invention are more apparent in the detailed description which follows, with reference to the accompanying drawings, which illustrate a preferred, non-limiting example embodiment of the invention, in which:

FIG. 1 is a perspective view of a first example embodiment of the invention;

FIG. 2 is a longitudinal section of the invention of FIG. 1;

FIG. 3 is a longitudinal section with some parts cut away to better illustrate others of a second example embodiment of the invention.

### DETAILED DESCRIPTION OF THE PREFERRED EMBODIMENTS OF THE INVENTION

The invention relates to an extensible band for external protection of building structures with irregular surfaces, comprising at least one supporting layer 1 and one covering layer 2 which are connected to each other and in which there is a plurality of micro-folds 3 extending transversally to the direction of elongation. The supporting layer 1 comprises a film 11 made of organic material and the covering layer 2 comprises a film 21 made of ductile metal.

The organic material film 11 may be produced using various types of synthetic compounds: for example, in a preferred embodiment, it may be made of polyester, but it may also be made of high or low density polyethylene, or even of polypropylene. The ductile metal film 21 is preferably produced using aluminium.

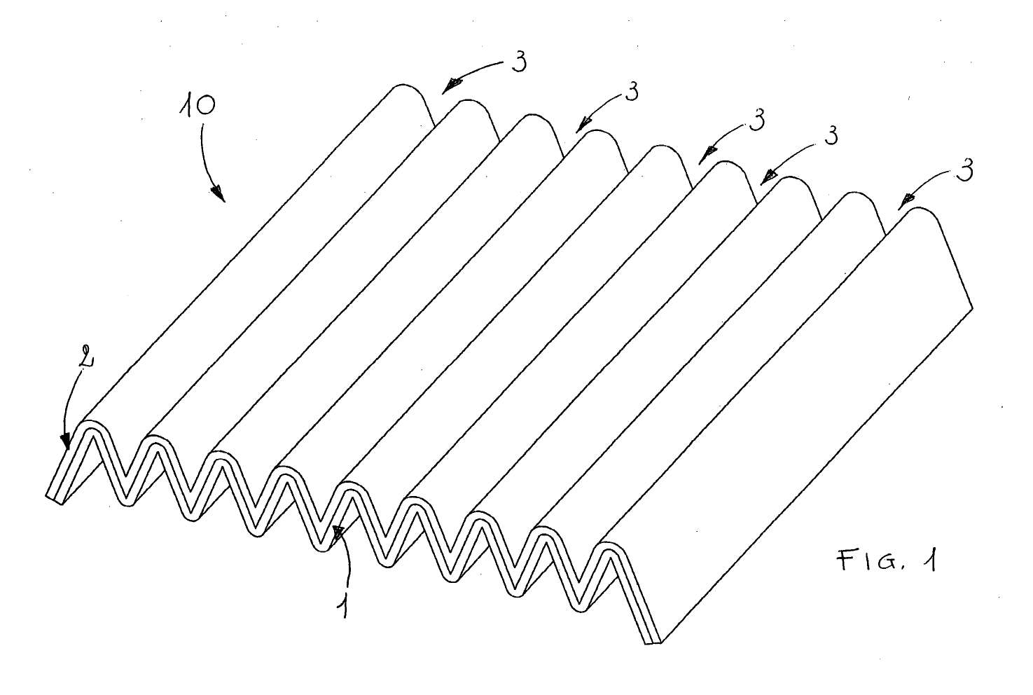

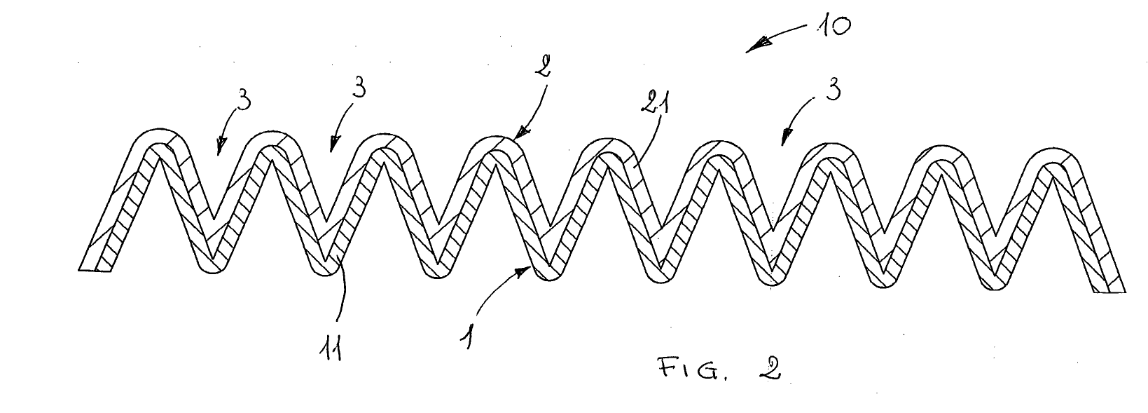

In addition to the two layers 1, 2 described above, which represent the minimum version of the invention, illustrated in FIGS. 1 and 2, the impermeability of the invention can also be achieved using an additional supporting layer 4 applied to the ductile metal film 21, so that the ductile metal film 21 is located between two supporting layers 1, 4.

The additional supporting layer 4 comprises a second organic material film 41, suitable for exposure to UV rays.

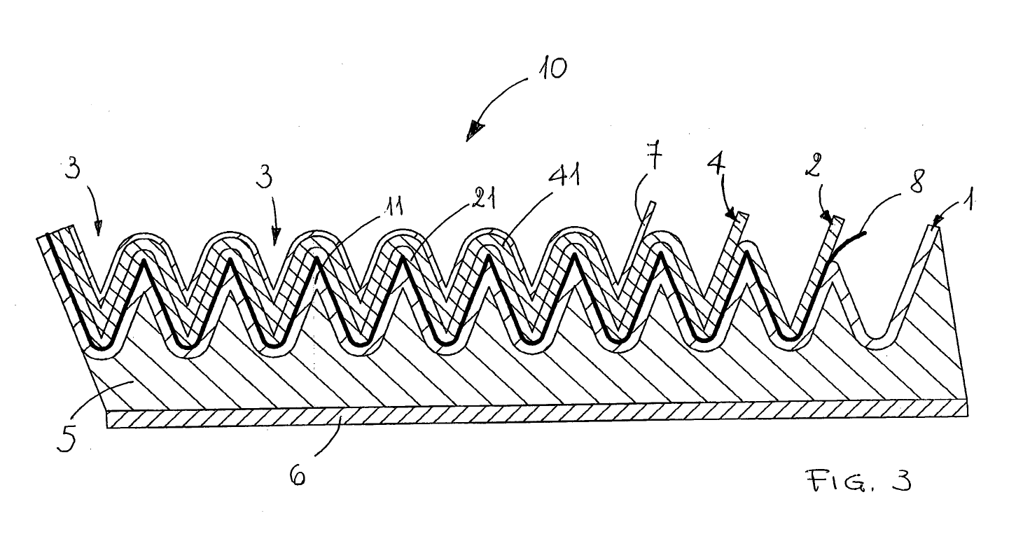

In a preferred embodiment, illustrated in FIG. 3, the band 10 also comprises a layer of adhesive 5, connected to the supporting layer 1 and designed to allow the band 10 to be applied to the surface to be protected. On top of the layer of adhesive 5 there is a removable non-adhesive film 6, applied to the layer of adhesive 5, said film 6 being designed to prevent unwanted application of the band 10.

If necessary, a layer of paint 7 may be placed on top of the outermost covering layer 2 of the band 10, giving it an attractive appearance.

The impermeability of the band 10 is also guaranteed by the join made between the organic material film 11 and the ductile metal film 21, which is designed to guarantee their cohesion. Said join may be made in various ways which are functionally equivalent: for example, a layer of adhesive material 8 may be inserted between them, or the organic material film 11 may be fused onto the ductile metal film 21.

The invention described above may be modified and adapted in several ways without thereby departing from the scope of the inventive concept. Moreover, all details of the invention may be substituted by technically equivalent elements.

Obviously, in practice modifications and/or improvements are possible which are covered by the following claims.

1. An extensible band for external protection of building structures with irregular surfaces, comprising at least one supporting layer (1) and one covering layer (2) which are connected to each other and involved by a plurality of micro-folds (3) extending transversally to the direction of elongation, the band being characterised in that the supporting layer (1) comprises a film (11) made of organic material and the covering layer (2) comprises a film (21) made of ductile metal, disposed outwardly in respect of the supporting layer (1).

2. The extensible band according to claim 1, further comprising an additional supporting layer (4) applied to the ductile metal film (21), in such a way that the ductile metal film (21) is located between two supporting layers (1, 4).

3. The extensible band according to claim 2, wherein the additional supporting layer (4) comprises a second organic material film (41), suitable for exposure to UV rays.

4. The extensible band according to claim 1, further comprising a layer of adhesive (5) connected to the supporting layer (1), said layer of adhesive (5) allowing the band (10) to be applied to the surface to be protected.

5. The extensible band according to claim 4, further comprising a non-adhesive removable protective film (6), applied to the layer of adhesive (5), the non-adhesive film (6) being designed to prevent unwanted band (10) applications.

6. The extensible band according to claim 1, further comprising a layer of paint (7), on top of the outermost layer (2; 4), the layer of paint (7) being designed to give an attractive appearance.

7. The extensible band according to claim 1, further comprising a layer of adhesive material (8) inserted between the organic material film (11) and the ductile metal film (21), guaranteeing their cohesion.

8. The extensible band according to claim 1, wherein the organic material film (11) is fused onto the ductile metal film (21), guaranteeing their cohesion.
